(19) United States
(12) Patent Application Publication
(10) Pub. No.: US 2021/0102036 A1
(43) Pub. Date: Apr. 8, 2021

(54) METHOD FOR PRIMING SILICONE SURFACES

(71) Applicant: Joerg NASS, Goch (DE)

(72) Inventor: Joerg NASS, Goch (DE)

(21) Appl. No.: 16/772,251

(22) PCT Filed: Dec. 17, 2018
(86) PCT No.: PCT/EP2018/085305

§ 371 Date: Jun. 12, 2020

(30) Foreign Application Priority Data
Jan. 8, 2018 (DE) 10 2018 100 214.9

(51) Int. Cl. C08J 7/04; C09D 183/04; C08G 77/04; C08K 5/5419

(52) U.S. Cl. CPC C08J 7/0427; C09D 183/04; C08G 77/04; C08J 2433/02; C08J 2383/04; C08J 2483/04; C08K 5/5419

(57) ABSTRACT

The method for priming silicone joints on windows, doors, glazing areas, sanitary facilities and the like is carried out using a mixture consisting of an impregnating agent, a lacquer and water or without water for priming silicone surfaces, wherein the mixture is produced from the components only immediately before use, wherein the impregnating agent contains an acid, is anhydrous and is a silicon dioxide precursor which hydrolyzes to form silicon dioxide particles in the acidic environment in the presence of water, and wherein the lacquer is a water-dilutable dispersion lacquer paint.

The invention relates to a method for priming silicone joints on windows, doors, glazing areas, sanitary facilities and the like.

### Prior Art

In contrast with the invention, the Euroteam company supplies joint tapes which are used in repeated application (DE 20 2015 006 906 U1). These joint tapes do not consist of silicone, but rather polyurethane. Although polyurethane can by all means be painted over, the joint tapes from the Euroteam company are provided for adhesion e.g. to concrete, stone, etc., but not for a subsequent coat of paint.

These products are in no way comparable to the present invention. The use and the area of application relate to an as yet unrelated field. Silicone joints are in fact construction joints that are already present on windows, doors, glazing areas, sanitary facilities, as well as construction facilities, e.g. in vehicles and machines.

DE 10 2008 002 250 A1 describes a coating agent for wiper rubbers of a wiper blade for windshield wipers of a motor vehicle. Instead of the wiper rubber, other elastomer materials can also be treated using the coating material. The coating process takes place in order to reduce or to completely change the noise emission during the wiping process. The coating agent contains at least one binder having at least one resin component, which can be tetramethoxysilane. A subsequent coating process using a painting system is not disclosed in this case.

The technical leaflet Rajasil NIG from HECK Wall Systems GmbH, 95615 Marktredwitz relates to a solvent-free, hydrophobic injecting, priming and impregnating agent based on silicone. This agent is provided for open-pore and absorbent substrates, i.e. not for silicone joints.

### Problem Addressed By The Invention And Solution To Same

Problem addressed by the invention: allowing existing, vulcanized silicone joints to be painted without running and with resistance to abrasion.

According to the invention, this problem is solved by the features of claim 1.

The following advantages, inter alia, are achieved: the glaze is compatible with most painting systems that are found on the market and are commercially available.

Application possibilities consist in preparing existing silicone joints on windows, doors, glazed areas, sanitary facilities, as well as construction facilities, for subsequent coating systems.

Instead of sealing compounds of inferior quality, such as acrylates, high-quality sealing compounds in the form of silicone can now be utilized, since the ability to be painted is now provided using the product according to the invention

A component A, specifically an impregnating agent, for example Rajasil NIG, and a component B, which consists of a lacquer glaze and water, for example a water-dilutable acrylic resin or another water-dilutable dispersion lacquer paint, are mixed and then immediately processed. The processing consists in applying the mixture to silicone joints as a primer. After a drying time of 24 hours, the primer can be painted over, i.e. the final painting can take place using painting systems that are commercially available.

In contrast with DE 10 2008 002 250 A1, the present invention does not relate to coating in order to reduce noise emission, but rather to priming a substrate which otherwise could not be painted over using commercially available and water-dilutable dispersion paints.

Firstly, the invention does not relate to coating in order to avoid creaking or other noise emission when one surface moves on another surface, but rather to a method for priming silicone joints for subsequent painting using water-dilutable dispersion lacquer paints.

Secondly, notwithstanding patent application DE 10 2008 002 250 A1 from Bosch published in 2009, up to now no solution of this kind is known on the market or in the literature, although there has been great need for this.

Advantageous embodiments of the invention are specified in the dependent claims.

### Practical Examples

In the following, a plurality of practical examples will be described in more detail.

### Example 1

A painter intends to paint over an existing apartment block having 4 stories and 16 residential units in the color white. The apartment block has 96 windows. There is therefore approximately 400 meters of silicone joints on the windows in the color grey. There are a further 150 meters of grey expansion joints on the building. There are thus 550 meters of silicone joints on the building.

There is no possibility of painting over the existing silicone joints. The painter now has to commission another company to remove existing joints and replace them so as to be suitable for the white paint. The cost of restoration and re-pointing is approximately EUR 6,000 net.

If the product according to the invention is now used by the painter, existing joints can be painted over. In addition to saving an enormous amount of time, the cost for providing the joints in the suitable color now amounts to approximately EUR 700 net (approx. 8 m² joint painting). The painter and his customer have thus saved on costs of almost 90%.

### Example 2

A drywall builder has been commissioned with the interior construction of a gypsum wall cladding. In order to finish his work ready for the painter, the drywall builder uses an acrylic sealing compound, as is conventional, in order to point the connection joints on the ceiling and the wall. However, the drywall builder is aware of the disadvantages of pointing using acrylic. In the past, when using this sealing compound that can be painted over, he has experienced on multiple occasions the situation whereby detachments occur after months or even years due to over-expansion, and customers have complained.

The cause is that acrylic is subject to shrinkage due to a high water content. The expandability of acrylate sealing compounds is also usually limited to 7%. This technical property results in the above-mentioned problems.

However, if the drywall builder now introduces a high-quality sealing compound based on silicone into the connection joints, the previously mentioned problems of detachments are eliminated owing to the higher movement absorption of the silicone (approx. 25% and higher).

Since the drywall builder or also the painter subsequently uses the product according to the invention, it is demonstrated that the product can be used by different craftsmen in various construction phases indoors and outdoors. Owing to the qualitative pointing, complaints are reduced, costs are saved, and a satisfied end customer is guaranteed.

### Production

Starting materials:

Component A:

10% nano-impregnation in the form of an anhydrous injecting and impregnation agent based on silicone in this particular case consisting of trimethoxy(2,4,4-trimethylpentyl)silane polydimethylsiloxane ethanoic acid methanol and available under the trade name Rajasil NIG from HECK Wall Systems GmbH, 95615 Marktredwitz.

The following commercially available products can alternatively be used

“Porofin”

“Bostik Kiesey Horizontalstopp Versiegelungskonzentrat”

“Remmers Kiesol rot”

“Ceresit BT CO 81 Verkieselung”

“TILAN Mautrol Borhloch-Flüssig”

“weber.tec Horizontalsperre SMK Silikonmikroemulsion”

“Nano Steinversiegelung StoneprotecT SP5000”

Component B:

68% lacquer glaze 22% water in this particular case consisting of water-dilutable acrylic resin and available under the trade name P-Weisslack 2in1 seidenmatt, SPWM 9110 from Wilckens Farben Gmbh; 25348 Glückstadt.

One special feature consists in mixing component A (impregnating agent) with component B (lacquer glaze). The mixed components clot, in particular depending on the ambient temperature, after only a few minutes. According to the invention, the components are therefore mixed, depending on the amount required, only shortly before use. In this way, a processing time of approx. 45 minutes can be achieved at a reference temperature of over 21° C.

Preparation:

Thoroughly mix in the above-mentioned ratios.

Since the product is formed from 2 components, component A and component B are mixed by the user according to instructions, on-site and as required.

Use:

The components are stirred together independently until a homogenous mass is formed.

The silicone substrate to be primed has to be cleaned of the present separating agent beforehand.

The emulsion is applied repletely to the surface. After a drying time of 24 hours, the final coating can take place. A repeated application of the emulsion is only necessary if, after a visual inspection, it transpires that the coverage is still not sufficient.

The product according to the invention can be used both inside and outside.

### Tests

Endurance tests of painted-over silicone joints were carried out with positive results under European weather conditions.

Silicone joints cannot be painted over without the product and method according to the invention.

All % signs should be understood to mean weight percentage.

Further advantages are that, for example when pointing windows or door systems, attention no longer has to be paid to a suitable color for the silicone sealant if the component in any case receives a different colored paint at the end.

Acrylic sealing compounds can be completely done away with in wet spaces, since these sealing compounds—in contrast with silicone—do not have any fungicidal properties.

Surfaces contaminated with silicone no longer have to be strenuously cleaned. They can be prepared for a new coating by means of the product according to the invention.

### Example 3

Component A: 130 ml 100% lacquer glaze, in this particular case consisting of water-dilutable acrylic 20 resin, available e.g. under the trade name P-WeiBlack 2in1 seidenmatt, SPWM 9110 from Wilckens Farben GmbH, 25348 Glückstadt.

Component B: 20 ml 100% nano-impregnation in the form of an anhydrous injecting and impregnating agent based on silicone, available e.g. under the trade name Rajasil NIG from HECK Wall Systems GmbH, 95615 Marktredwitz.

### Example 4

A one-component product consisting of 60% lacquer glaze and 40% film-forming polymers (contained e.g. in hair gel).

The product only has to be stirred before use and should be used like a normal paint.

1. A method for priming silicone joints on windows, doors, glazing areas, sanitary facilities and the like, using comprising:
producing a mixture of components consisting of an impregnating agent, a lacquer, and water or without water, and
priming silicone surfaces of the silicone joints,
wherein the mixture is produced from the components only immediately before the step of priming, wherein the impregnating agent contains an acid, is anhydrous and is a silicon dioxide precursor which hydrolyzes to form silicon dioxide particles in the acidic environment in the presence of water, and wherein the lacquer is a water-dilutable dispersion lacquer paint.

2. The method according to claim 1, wherein the mixture consists of 5-15% anhydrous injecting and impregnating agent, 60-75% lacquer glaze, and 20-25% water.

3. The method according to claim 1, wherein the silicon dioxide precursor is tetraethyl silicate.

4. The method according to claim 1, wherein the mixture consists of 10% anhydrous injecting and impregnating agent 68% lacquer glaze, and 22% water.

5. The method according to claim 1, wherein the mixture consists of 80-90% water-dilutable acrylic resin, and 10-20% anhydrous injecting and impregnating agent.
